(19) United States
(12) Patent Application Publication
(10) Pub. No.: US 2022/0294121 A1
(43) Pub. Date: Sep. 15, 2022

(54) GRADIENT-INDEX LENS BASED COMMUNICATION SYSTEMS

(71) Applicant: Lunewave, Inc., Tucson, AZ (US)

(72) Inventors: Hao Xin, Tuscon, AZ (US); Min Liang, Tuscon, AZ (US); Jiang Xin, Wellesley, MA (US)

(21) Appl. No.: 17/630,188

(22) PCT Filed: Jul. 29, 2020
(86) PCT No.: PCT/US20/44016

§ 371 Date: Jan. 26, 2022

Related U.S. Application Data
(60) Provisional application No. 62/880,583, filed on Jul. 30, 2019.

(51) Int. Cl. H01Q 15/08; H01Q 19/06; G01S 13/42

(52) U.S. Cl. CPC H01Q 15/08; H01Q 19/06; G01S 13/42

(57) ABSTRACT

A communication system includes a Gradient-index lens, a first plurality of antenna elements, and a control system. The first plurality of antenna elements are arranged on a first surface parallel to a surface of the Gradient-index lens. The first plurality of antenna elements are configured to generate a first plurality of antenna signals in response to receiving a signal from an end user device. The control system receives the first plurality of antenna signals from the first plurality of antenna elements and determines an end user direction associated with the end user signal based on a predetermined set of antenna signal values associates with the first plurality of antenna elements.

### PRIORITY CLAIM

This application claims benefits of priority to U.S. Provisional Application No. 62/880,583 filed Jul. 23, 2019, the entire contents of which are incorporated herein by reference.

### TECHNICAL FIELD

The present disclosure relates generally to a communication system, and more particularly, to a gradient index lens based reconfigurable communication system.

### BACKGROUND

Gradient index (GRIN) components are electromagnetic structures that can exhibit spatially-continuous variations in their index of refraction n. The Luneburg lens is an attractive gradient index device for multiple beam tracking because of its high gain, broadband behavior, and ability to form multiple beams. Every point on the surface of a Luneburg lens is the focal point of a plane wave incidents from the opposite side. The permittivity distribution of a Luneburg Lens is given by:

$${ε}_{r} = 2 - {( \frac{r}{R} )}^{2}$$

where εᵣ is the permittivity, R is the radius of the lens and r is the distance from the location to the center of the lens.

In current technologies, a 3 dimensional (“3D”) printed Luneburg lens structure is constructed by controlling the filling ratio between the polymer of the lens and air. Most of the lens structure is typically made of polymer; therefore, the overall weight increases significantly when the size of the lens increases. Further, fabrication costs associated with current technologies are typically high for larger lens sizes.

It thus would be desirable to have new lens structures.

### SUMMARY

According to one aspect, the present disclosure provides a communication system that includes a gradient-index lens (e.g., Luneburg lens), a first plurality of antenna elements, and a control system. The first plurality of antenna elements are arranged on a first surface parallel to a surface of the Luneburg lens. Additionally, the first plurality of antenna elements may be configured to generate a first plurality of antenna signals in response to receiving a signal from an end user device. The control system is configured to receive the first plurality of antenna signals from the first plurality of antenna elements and determine an end user direction associated with the end user signal based on a predetermined set of antenna signal values associated with the first plurality of antenna elements.

In addition, the predetermined set of antenna signal values includes a plurality of subsets of voltage signal values and the plurality of subsets of voltage signal values are indicative of a plurality of predetermined end user signal directions.

In some aspects, to determine the end user direction, the control system is configured to execute a correlation and/or a compressive sensing algorithm that calculates a plurality of correlation values between the first plurality of antenna signals and the plurality of subsets of voltage signals values and select the end user direction from the plurality of predetermined end user signal directions based on the calculated plurality of correlation values. Additionally, the control system generates a control signal and the first plurality of antenna elements are configured to generate and scan a reference signal in a solid angle based on the control signal. The end user device may be configured to generate the end user signal in response to receiving the reference signal.

In particular, the reference signal includes a pulsed and/or a frequency modulated signal and the control system is configured to determine an end user distance between the communication system and the end user device based on a time difference between a first time of transmission of the reference signal and second time of reception of the signal from the end user signal. The control system is further configured to generate a second plurality of control signals to control the operation of the first plurality of antenna elements based on the end user direction and the end user distance.

In further aspects, the plurality of antenna elements are arranged in an azimuth plane of the Luneburg lens and/or in a sector of elevation of the Luneburg lens. A first Luneburg lens includes a birefringent material configured to focus a first beam having a first polarization at a first distance from the surface of the Luneburg lens and focus a second beam having a second polarization at a second distance from the surface of the Luneburg lens. The first surface is located at the first distance from the surface of the Luneburg lens and the first plurality of antenna elements are configured to generate radiation having the first polarization.

In additional aspects, a second plurality of antenna elements are arranged on a second surface parallel to the surface of the Luneburg lens. The second surface is located at the second distance from the surface of the Luneburg lens. The second plurality of antenna elements are configured to generate radiation having the second polarization. Additionally, a first antenna element of the first plurality of antenna elements has a first orientation and a second antenna element of the second plurality of antenna elements has a second orientation.

The control system may include a controller and a third plurality of control circuitry configured to generate one or more control sub-signals. The control signal includes the one or more control sub-signals and the controller is configured to determine the amplitude and/or phase of the one or more control sub-signals.

In some aspects, the first plurality of antenna elements have a characteristic bandwidth and the controller is configured to determine an operational bandwidth of the one or more control sub-signals. The operational bandwidth lies within the characteristic bandwidth.

In another aspect, the first plurality of antenna elements have a characteristic bandwidth and the controller is configured to vary the characteristic bandwidth by reorganizing radiating sections of the first plurality of antenna elements. The first plurality of antenna elements may be reconfigurable antenna (e.g., reconfigurable pixelated printed monopole).

The system may further include a switch matrix configured to electrically connect the first plurality of antenna elements and the third plurality of control circuitry. The switch matrix is configured to connect a first antenna element of the first plurality of antenna elements to a first control circuitry of the third plurality of control circuitry during a first time period and to a second control circuitry of the third plurality of control circuitry during a second time period.

In additional aspect, the control system is configured to generate a second control signal and the first plurality of antenna elements are configured to generate a communication signal directed to the end user device based on the second control signal. The control system is further configured to determine an interference direction associated with an interference signal and generate a reconfiguration signal. The first plurality of antenna elements are configured to generate a null beam directed along the interference direction based on the reconfiguration signal.

According to another aspect, the present disclosure provides a method of determining an end user direction. In particular, the method includes providing a communication system having a gradient-index lens (e.g., Luneburg lens), a first plurality of antenna elements arranged of a first plurality of antenna elements arranged on a first surface parallel to a surface of the Luneburg lens and a control system and then generating, by the plurality of antenna elements, a first plurality of antenna signals in response to receiving a signal from an end user device. The control system then determines the end user direction associated with the end user signal based on a predetermined set of antenna signal values associated with the first plurality of antenna elements.

Notably, the present invention is not limited to the combination of the communication system elements as listed above and may be assembly in any combination of the elements as described herein.

Other aspects of the invention as disclosed infra.

### BRIEF DESCRIPTION OF THE DRAWINGS

The patent or application file contains at least one drawing executed in color. Copies of this patent or patent application publication with color drawings will be provided by the Office upon request and payment of the necessary fee.

The embodiments herein may be better understood by referring to the following description in conjunction with the accompanying drawings in which like reference numerals indicate identically or functionally similar elements, of which:

FIG. 1 illustrates a schematic view of an exemplary communication system;

FIG. 2 illustrates an exemplary Luneburg lens based communication system that determines the direction of arrival (DOA) of an incoming signal;

FIG. 3 illustrates an experimental setup for DOA estimation system;

FIG. 4A illustrates an exemplary plot of estimated direction versus the actual incident angle for DOA estimation in FIG. 3;

FIG. 4B illustrates an exemplary plot of measured angle error versus the actual incident angle for system in FIG. 3;

FIG. 5A illustrates exemplary modified Luneburg lenses;

FIG. 5B illustrates exemplary elevation radiation patterns of the modified Luneburg lenses in FIG. 5A;

FIG. 5C illustrates exemplary horizontal radiation patterns of the modified Luneburg lenses in FIG. 5A;

FIG. 6A illustrates an exemplary calculated angle finding probability results of an incident wave from −70 degree using the compressive sensing (CS) algorithm;

FIG. 6B illustrates an exemplary calculated angle finding results of an incident wave from −70 degree using the correlation algorithm;

FIG. 7A illustrates a plot of a simulation of a broadband Vivaldi antenna operation;

FIG. 7B illustrates a plot of a simulation of return loss corresponding to FIG. 7A;

FIG. 8A illustrates exemplary simulated radiation patterns for one antenna element and multiple antenna elements;

FIG. 8B illustrates the one antenna element arrangement in FIG. 8A;

FIG. 8C illustrates the multiple antenna element arrangement in FIG. 8A;

FIG. 9 illustrates an exemplary array of Vivaldi antenna elements coupled to a Luneburg lens;

FIG. 10 illustrates the simulated radiation pattern of the Luneburg lens with different antenna feeds;

FIG. 11A illustrates a two-switch monopole antenna;

FIG. 11B illustrates a three-switch monopole antenna;

FIG. 11C illustrates a plot of reflection coefficient for the two-switch antenna in FIG. 11A;

FIG. 11D illustrates a plot of reflection coefficient for the three-switch antenna in FIG. 11B;

FIG. 12 illustrated exemplary scanning patterns for the Luneburg lens generated by five adjacent antenna elements of the DOA estimation system in FIG. 3;

FIG. 13A illustrates a fan beam generated by 36 antenna elements;

FIGS. 13B and 13C illustrate plots of magnitudes and phases of the excitation signals applied to the 36 antenna elements in FIG. 13A;

FIG. 14A illustrates formation of a null beam by 36 antenna elements;

FIGS. 14B and 14C illustrate plots of magnitudes and phases of the excitation signals applied to the 36 antenna elements in FIG. 14A;

FIG. 15 illustrates simultaneous generation of four beams directed at different angles;

FIG. 16 illustrates an exemplary switching matrix configuration;

FIG. 17 illustrates another exemplary switching matrix configuration;

FIG. 18 illustrates yet another exemplary switching configuration; and

FIG. 19 illustrates an exemplary switching configuration.

It should be understood that the appended drawings are not necessarily to scale, presenting a somewhat simplified representation of various preferred features illustrative of the basic principles of the disclosure. The specific design features of the present disclosure as described herein, including, for example, specific dimensions, orientations, locations, and shapes will be determined in part by the particular intended application and use environment.

In the figures, reference numerals refer to the same or equivalent parts of the present disclosure throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

There is an increase in demand for fast and efficient communication systems in various fields ranging from autonomous vehicles to high-speed wireless data transfer. Gradient index lens based communication systems allow for fast detection of a target object (e.g., an end user device) by leveraging the novel properties of the gradient index lens (e.g., Luneburg lens) with reconfigurable antenna elements arranged around the surface of the Luneburg lens. These communication systems employ a broad fan beam or multiple beams for simultaneous communication with multiple targets and generate a null beam to mitigate interference processes. This provides improved spectral efficiency and reduction of errors in data transfer.

In one preferred aspect, the present invention features a hollow light weight, low-cost, and high performance 3D Luneburg lens structure using partially-metallized thin film, string, threads, fiber or wire-based metamaterial.

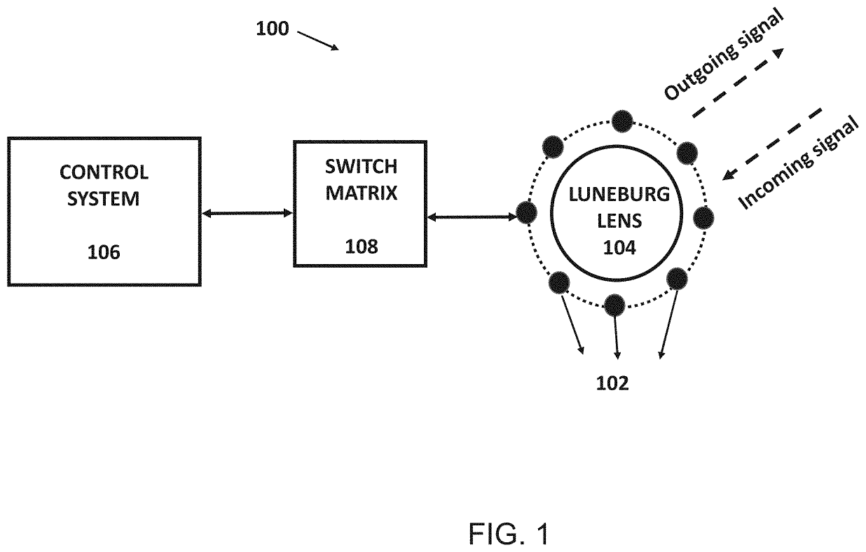

FIG. 1 illustrates a schematic view of an exemplary communication system 100. The communication system may include an array of antenna elements 102 arranged on (or around) a surface of Luneburg lens 104. The operation of the antenna elements 102 may be controlled by a control system 106 in electrical communication with the antenna elements 102. The control system 106 may include multiple control circuits configured to control the operation of the antenna elements. For example, the control system 106 can transmit a control signal to cause the antenna elements 102 to generate an outgoing signal (e.g., radiation with frequency ranging from about 100 MHz to about 1 THz). The control signal may include multiple control sub-signals that are generated by the various control circuits. A given control circuit may generate a control sub-signal characterized by an amplitude, a phase and a frequency. The amplitude, phase and frequency of the control sub-signal may determine the amplitude, phase and frequency of radiation emitted by an antenna element receiving the control sub-signal. The control system may determine the properties of the outgoing signal (e.g. frequency, amplitude, directionality, tunability, etc.) by varying the amplitude, phase and frequency of the various control sub-signals.

The control circuits may receive antenna signals from the antenna elements that are generated upon the detection of an incoming signal by the antenna elements. The control system 106 may determine various properties of the incoming signal (e.g., directionality, distance of the device generating the incoming signal, etc.) based on the antenna signals. Based on the incoming signal properties, the control system may improve (e.g., optimize) communication with an end user device. In some implementations, the communication system may include a switching matrix 108 that may electrically couple multiple antenna elements 102 to a given control circuit or vice-versa. The switching matrix 108 may vary the electrical coupling between antenna elements 102 and control circuits as a function of time.

Moreover, in wireless communication systems (e.g., 5G communication systems) it is desirable to identify and localize a user device by determining a location thereof. The localization may be achieved by determining the direction of an incoming signal from the device and the distance of the device from the communication system. A Luneburg lens based communication system may transmit a reference signal to the user device and receive a reference signal back from the end user (e.g., a return reference signal). From the reference signal, the location of the user device may be determined.

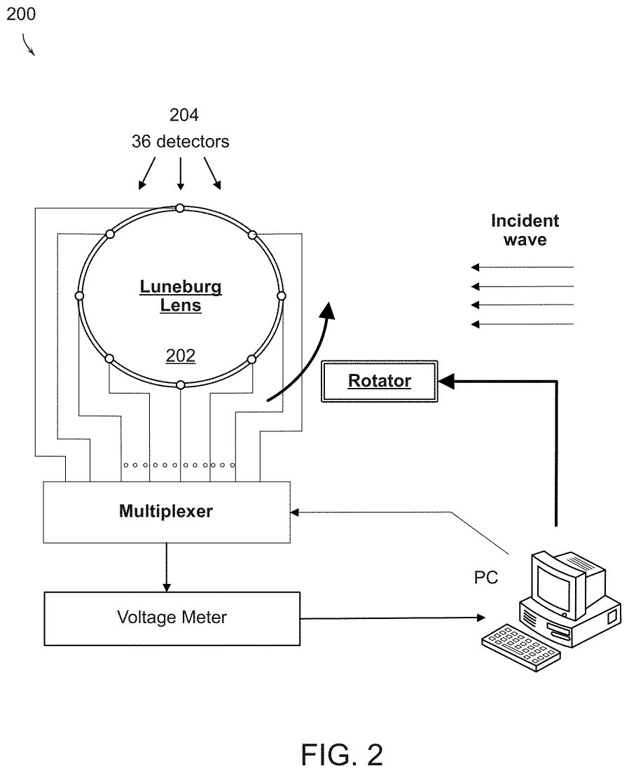

Accordingly, FIG. 2 illustrates an exemplary Luneburg lens based communication system 200 for determining the direction of arrival (DOA) of an incoming signal. In particular, the communication system may include the Luneburg lens 202 and a plurality of detectors 204 (e.g., antenna elements) arranged around the Luneburg lens. The Luneburg lens 202 may focus an incident plane wave to the focal point on the opposite side of the lens. Therefore, if detectors 204 are distributed around the lens 202, different detectors will generate detector signals (e.g., output voltages) with different power levels. For example, the detector directly facing the incident wave will generate a detector signal with highest power and the other detectors will generate detector signals with less or no power. By distributing a number of detectors and analyzing their output responses, the direction of the incident wave may be estimated.

In one implementation, a correlation algorithm may be used for direction of arrival (DOA) estimation. First, the output voltages of all the detectors are recorded with different incident angles from 0° to 360° (step 1°) with the Luneburg lens at far field distance from the source. These voltage values at different incident angles may be stored as the calibration file Veal. The calibration file may include multiple arrays of voltage values corresponding to different directions of incoming signal. Each array of voltage values may include output voltage values corresponding to the various detectors arranged around the Luneburg lens.

During the DOA measurement, the output voltages (V_{signal}) of all the detectors may be measured and correlated with the calibration file. The correlation may be calculated using the following equation:

Corr=ΣV_{cal}·V_{signal}

The direction with a largest correlation may be determined as the estimated direction of the incident wave.

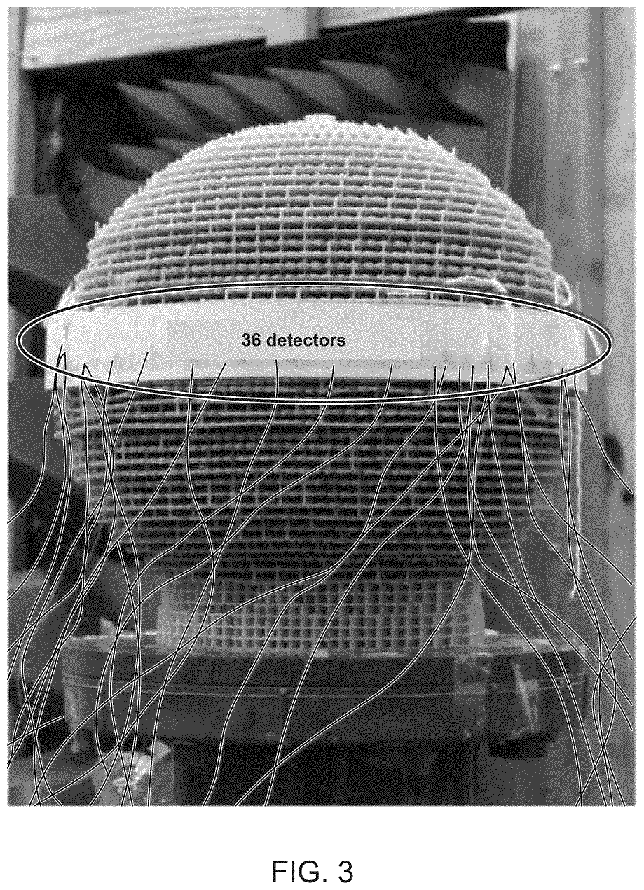

Further, a signal generator (e.g., Agilent E8257C) connected to a double ridged horn antenna may be used as the source of incoming signal. An operating frequency of about 5.6 GHz may be selected for the incoming signal. At this frequency, the detectors may have peak sensitivity. FIG. 3 illustrates an experimental setup for DOA estimation system. In particular, 36 antenna elements (e.g., detectors) with a separation of 10 degrees are mounted on the surface of the Luneburg lens. The distances from the transmitting horn to the Luneburg lens are 3 m and 4 m, for the calibration and the performance test, respectively (both in the far-field). The detector is made of a zero biased diode (SMS7630-061) fed by a monopole antenna printed on an 8-mil Duroid substrate.

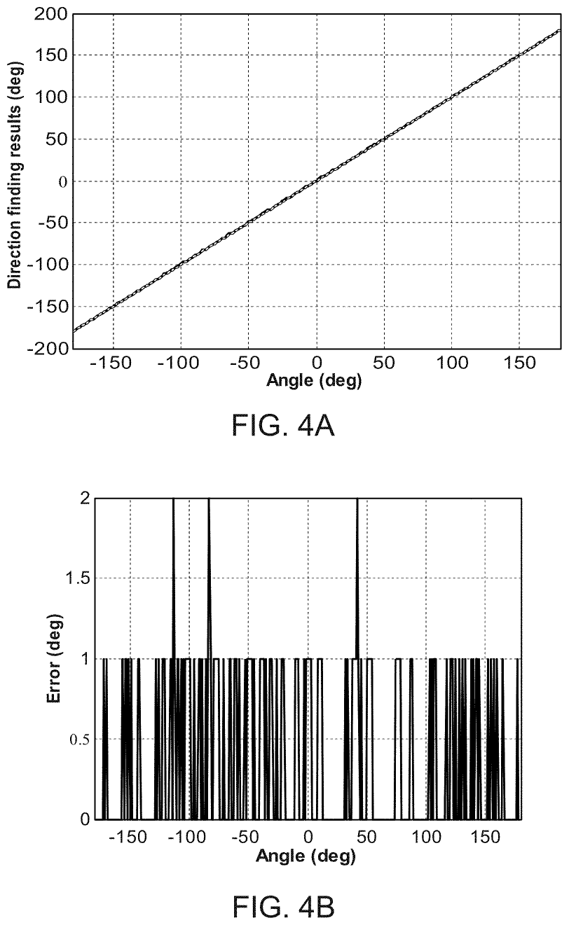

FIG. 4A illustrates an exemplary plot of estimated direction versus the actual incident angle for DOA estimation in FIG. 3. FIG. 4B illustrates an exemplary plot of measured angle error versus the actual incident angle for system in FIG. 3. The error of this correlation algorithm using this 36 detector Luneburg lens system is less than 2° for incident angles from all 360°. The averaged error over all 360 degree incident angles is 0.14 degree. If detectors are populated in a 3-D fashion on the lens surface, more accurate 3D direction finding may be obtained.

By applying the DOA estimation algorithm on the reference signal (e.g., a pulsed signal, FMCW signal, etc.), direction information of the end user may be obtained. The reference signal may be used to obtain the distance information of the end user device. For example, distance information may be determined by calculating the difference a time difference between a first time of transmission of the reference signal and a second time of reception of the signal from the end user signal. In other implementations, the distance may be completed by applying a pulsed/FMCW radar algorithm. With the direction and distance information of the end user, power and beam pattern of outgoing beam from the base station side may be adaptively changed to improve the efficiency of the communication system.

In some implementations, a compressive sensing (CS) based algorithm may be also applied to estimate the direction of incoming signal from the end user device. Prior to the DOA estimation method described above, the output voltages of all the detectors are recorded with different incident angles from 0° to 360° (step 1°) as the calibration data. Using the calibration data as the projection bases, compressive sensing algorithm (e.g., TWIST algorithm) may be applied to calculate the probability of signal coming from different directions. Compared to simple correlation algorithm, DOA estimation using CS algorithm may provide the probability of incident wave for different directions.

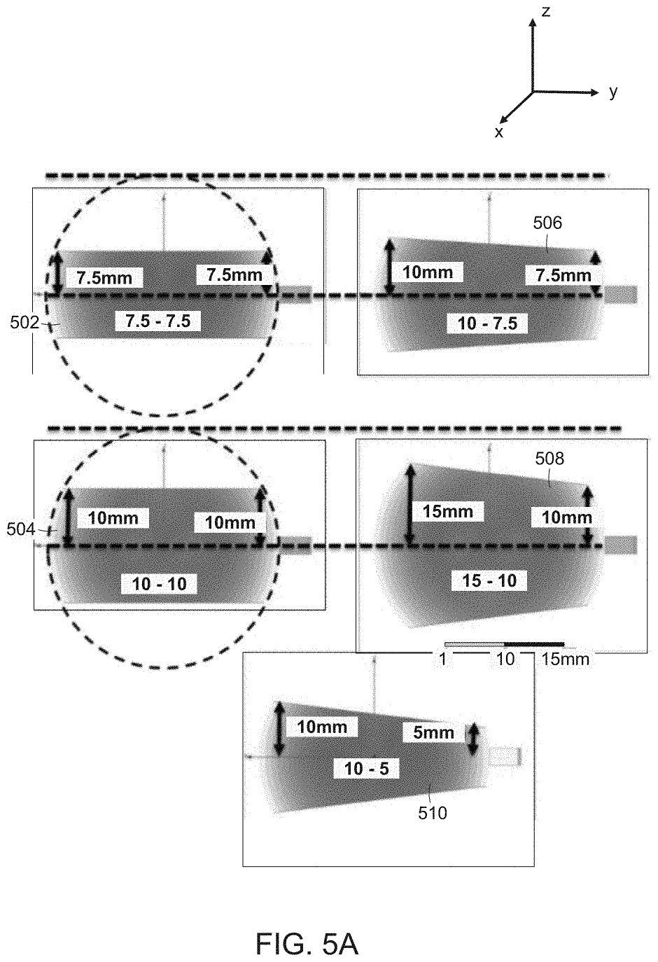

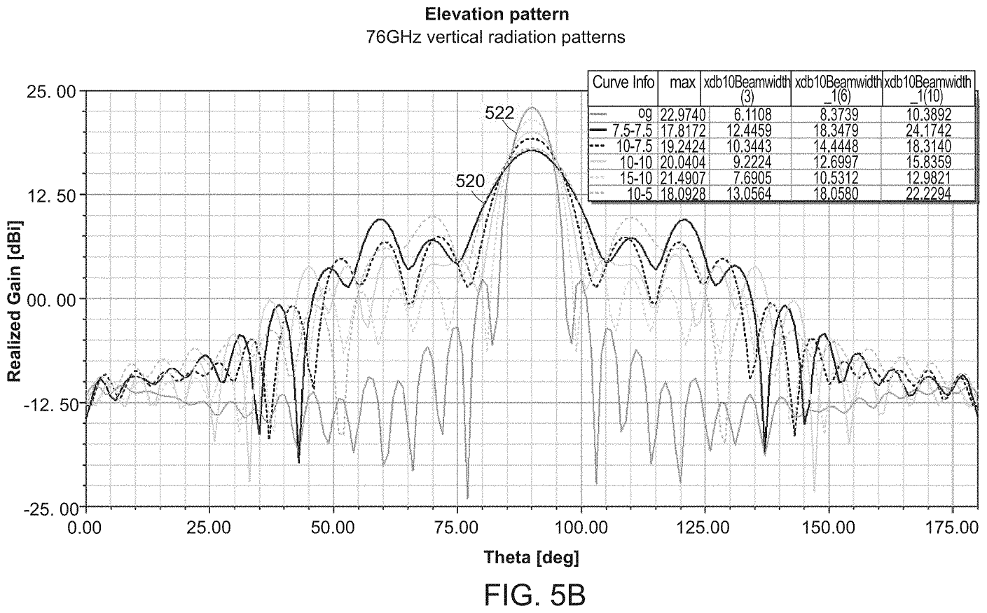

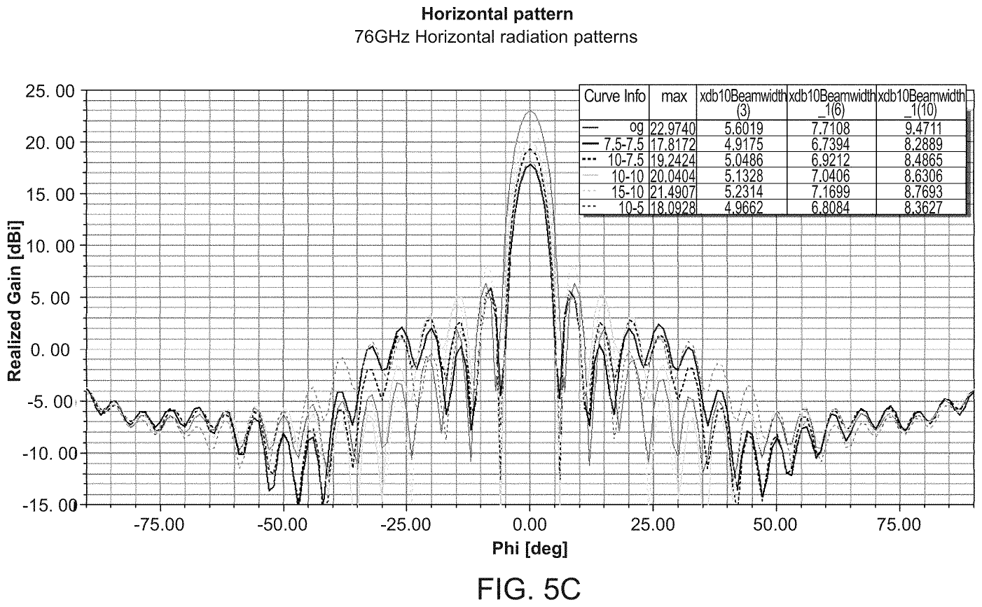

FIG. 5A illustrates exemplary modified Luneburg lenses. Modified Luneburg lens may be created by varying the shape of a spherical Luneburg lens (e.g., by making a planer cut in the spherical Luneburg lens) or varying the dielectric property distribution in the lens or both. Modified Luneburg lens may change the horizontal (in the x-y plane) and/or vertical (in the x-z plane) radiation pattern of antenna elements coupled to the modified Luneburg lens. In some implementations, the width of the radiation pattern of a modified Luneburg lens may be wider than the corresponding spherical Luneburg lens (e.g., width of central lobe of the radiation pattern). A broader central lobe may be desirable, for example, when a base station is attempting to locate an end user device.

Modified Luneburg lens 502-510 are obtained by making a planer cut to a spherical lens (e.g., planer cut both above and below the azimuth [x-y] plane). Modified lens 502 is obtained by making horizontal planer cuts at a distance of 7.5 mm from the azimuth plane. Modified lens 504 is obtained by making horizontal planer cuts at a distance of 10 mm from the azimuth plane. Modified lens 506 has a height of 10 mm relative to the azimuth plane and one end and a height of 7.5 mm relative to the azimuth plane at the diametrically opposite end. Modified lens 508 has a height of 15 mm relative to the azimuth plane and one end and a height of 10 mm relative to the azimuth plane at the diametrically opposite end. Modified lens 510 has a height of 10 mm relative to the azimuth plane and one end and a height of 5 mm relative to the azimuth plane at the diametrically opposite end.

FIG. 5B illustrates exemplary elevation radiation patterns (radiation pattern in the x-z plane) of the modified Luneburg lenses 502-510 and the spherical Luneburg lens from which lenses 502-510 are obtained. As discussed above, the central lobe 520 of the modified Luneburg lens 502 is broader than the central lobe 522 of a spherical Luneburg lens from which the modified Luneburg lens 502 is obtained. FIG. 5C illustrates exemplary horizontal radiation patterns (radiation pattern in the x-y plane) of the modified Luneburg lenses 502-510 and the spherical Luneburg lens from which lenses 502-510 are obtained.

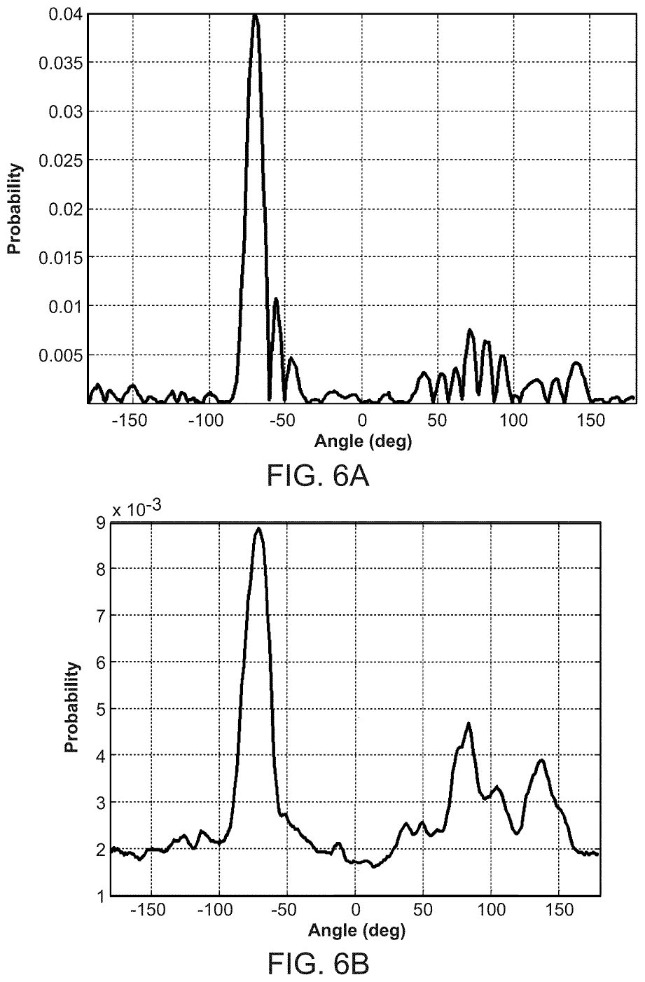

FIG. 6A illustrates an exemplary calculated probability results of an incident wave from −70 degree using the CS algorithm. FIG. 6B illustrates an exemplary calculated angle finding results of an incident wave from −70 degree using the correlation algorithm. The CS based algorithm has narrower beam width which is indicative of improved accuracy than the correlation based algorithm. Narrow beams may be used to communicate with single point end user to improve overall spectrum efficiency.

As discussed above, the control system may generate a control signal for operating the antenna elements. The control signal may vary the operation of the antenna elements (e.g., vary polarization, frequency, direction, spatial localization, etc. of the outgoing signal). In some implementations, the operation variation may include varying the amplitude, phase and frequency of the control sub-signals (“Wide Band feed approach”). In other implementations, the operation variation may include reconfiguring the antenna elements by altering the properties of the antenna elements (“Narrow Band feed approach”).

In the wide band feed approach, each antenna element may generate radiation having a broad characteristic frequency range (“characteristic bandwidth”), and the control system may select an operational bandwidth of the antenna elements (e.g., an operation bandwidth narrower than the operational bandwidth). In some implementations, selection of the operational bandwidth may be achieved by a digital common module.

The wide-band feed approach may have several advantages. For example, since there are no switching and/or tuning devices, the associated loss, power handling, nonlinearity and bias circuitry complexity may be prevented. Second, due to the unique features of Luneburg lens beam switching, standard challenging issues associated with a conventional wideband array such as grating lobes for high frequency band and mutual coupling is prevented.

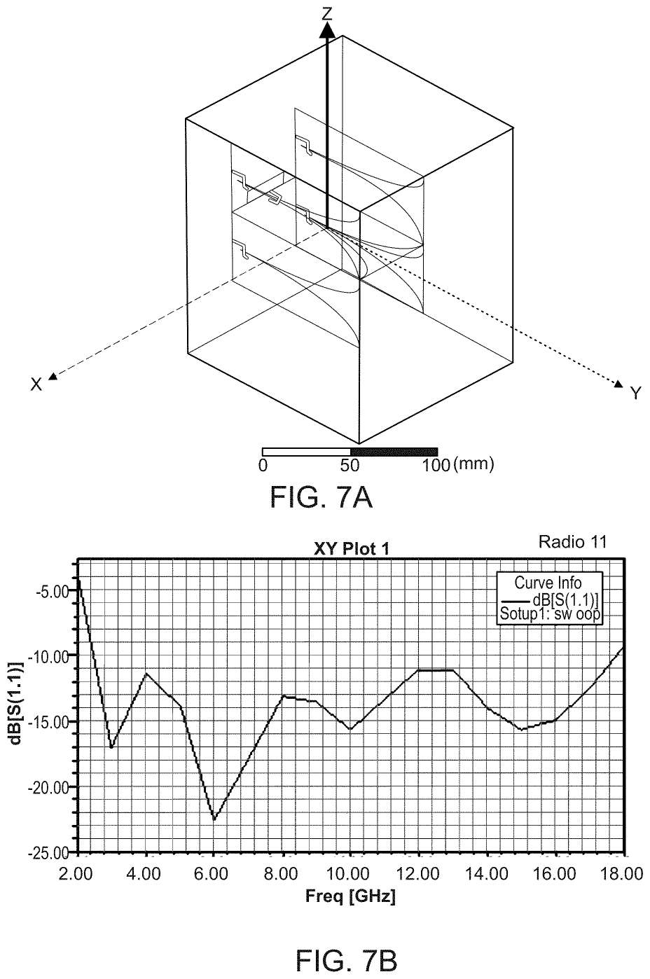

Furthermore, FIG. 7A illustrates a plot of a simulation of operation of a broadband Vivaldi antenna (e.g., operation based on wide band feed approach). FIG. 7B illustrates a plot of simulation of return loss corresponding to FIG. 7A. The Vivaldi antenna may have a characteristic frequency ranging between about 2 and 18 GHz. The simulation is based on HFSS model that includes interference between radiation having different polarization (e.g., polarization rotated by 90 degrees.). The simulation of return loss illustrated in FIG. 7B indicates satisfactory frequency response.

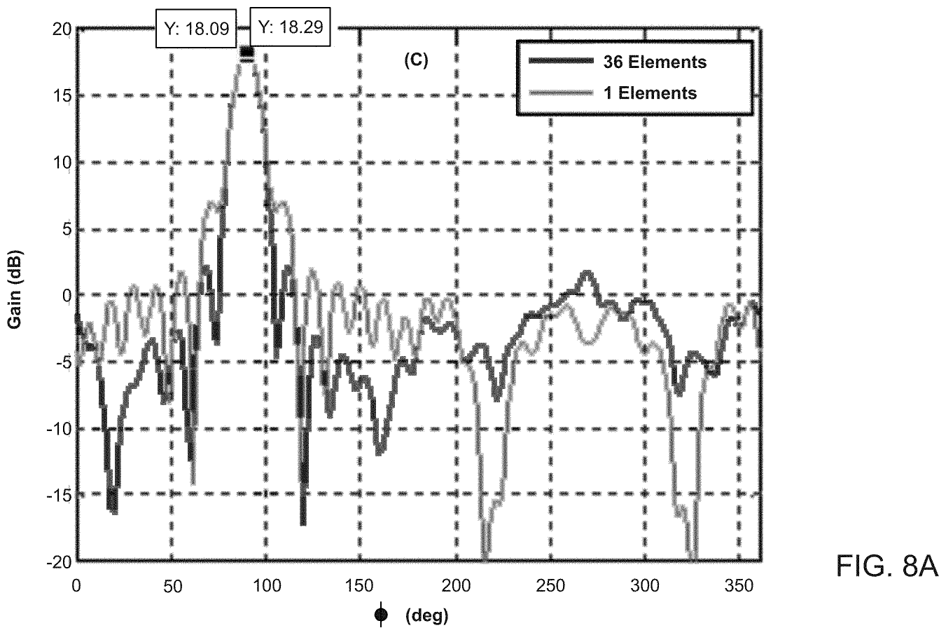

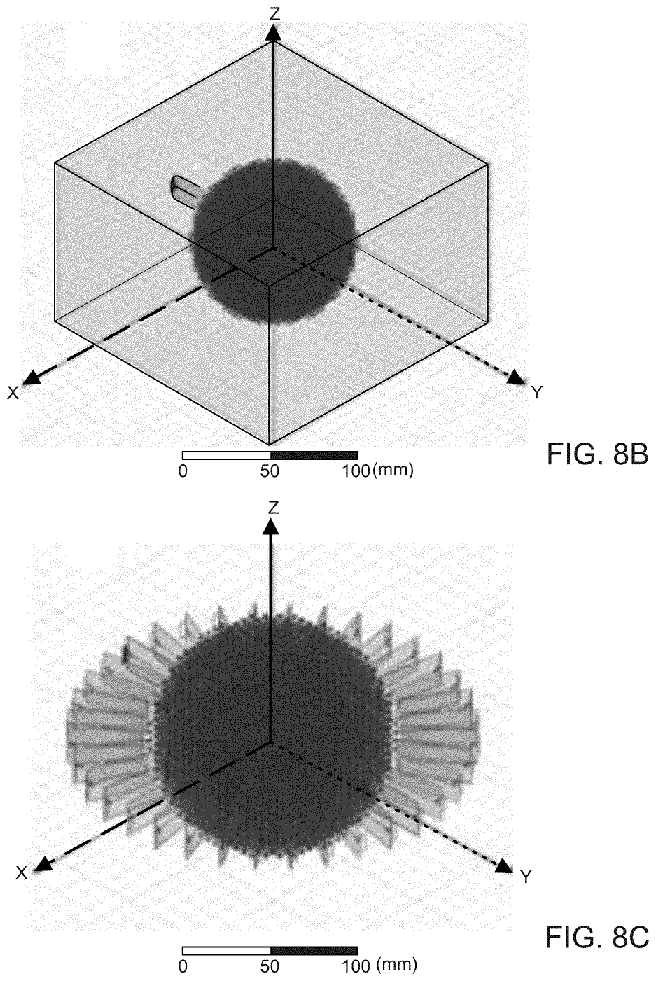

A Vivaldi antenna fed Luneburg lens (12-cm diameter example used here) has been designed. FIG. 8A illustrates exemplary simulated radiation patterns for one antenna element (shown in FIG. 8B) and multiple antenna elements (shown in FIG. 8C). The simulation is based on HFSS model. To evaluate the potential blockage and interference/mutual coupling effects for an array of antenna elements, a 36 antenna element array distributed along the lens equator with 10 degrees spacing is modeled. FIG. 8A indicates that for both the single feed element (shown in FIG. 8B) and 36 feed elements with only one excited element (shown in FIG. 8C), expected radiation patterns are obtained. The main beams for these two cases show that there is no blockage by the feed on the opposite side of the lens. Moreover, the simulated mutual coupling between any of the elements is less than −15 dB.

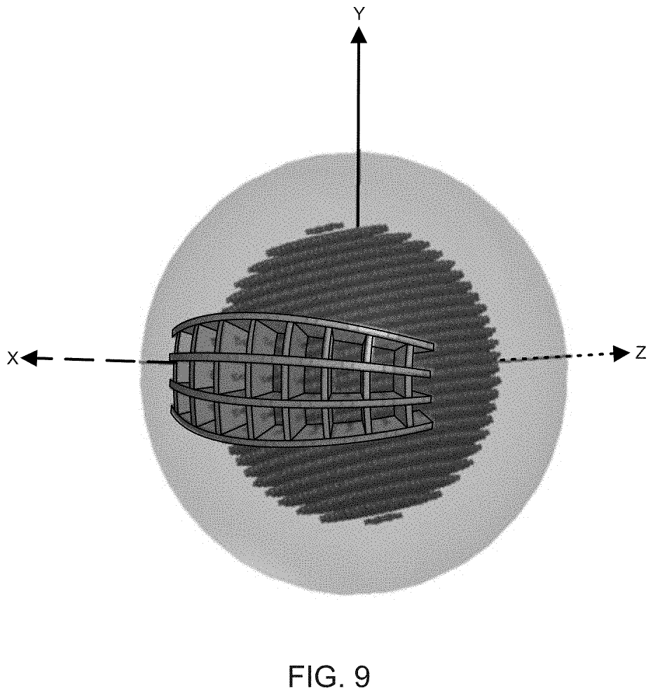

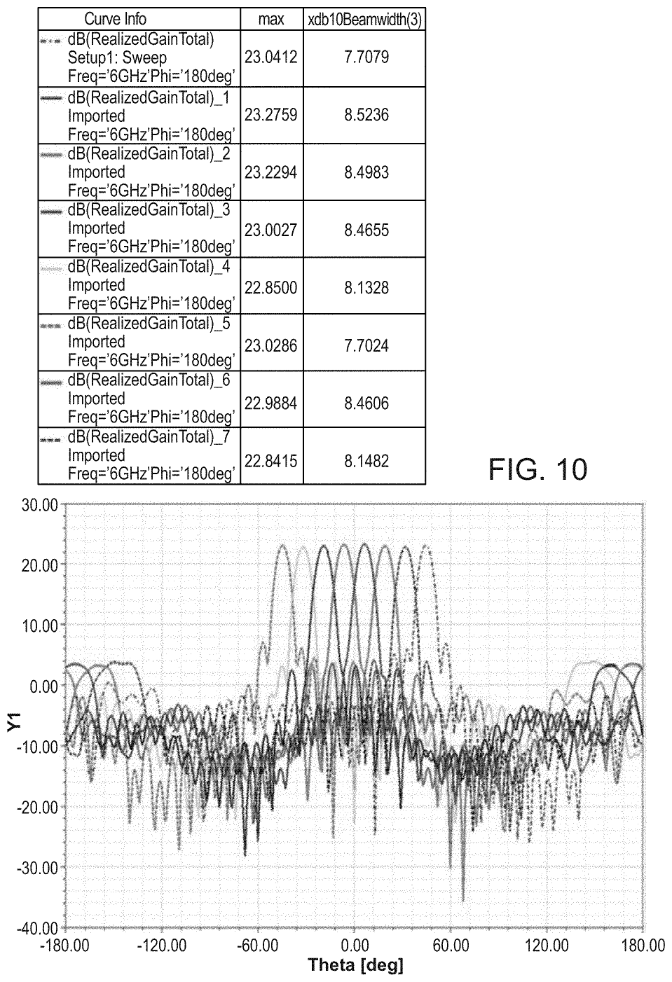

An array of Vivaldi antenna element for the Luneburg lens may be also applied to achieve both Azimuth and Elevation angle coverage. FIG. 9 illustrates an exemplary use of 48 Vivaldi antennas elements with a Luneburg lens. FIG. 10 illustrates the simulated radiation pattern of the Luneburg lens with different antenna feeds. This indicates that high directional beam may be achieved covering all fields of view (FOV).

In narrow band feed approach, tunable narrow band antenna feed may be used to achieve wideband coverage. This approach utilizes relatively narrowband antennas elements with tunable and/or switchable properties. In this approach, the antenna element provides band pass filtering that may lead to reduced demand on the common circuit module. Tunable narrow band antennas may be compact which may allow for smaller communication system design. MEMS switches may be used for “pixelated” frequency reconfiguration by connecting/reorganizing different radiating sections of an antenna element for coarse tuning of radiation frequency. Fine tuning of radiation frequency may be achieved via a semiconductor varactor. In one implementation, a reconfigurable pixelated printed monopole may be used to achieve about 2-4 GHz of frequency operation.

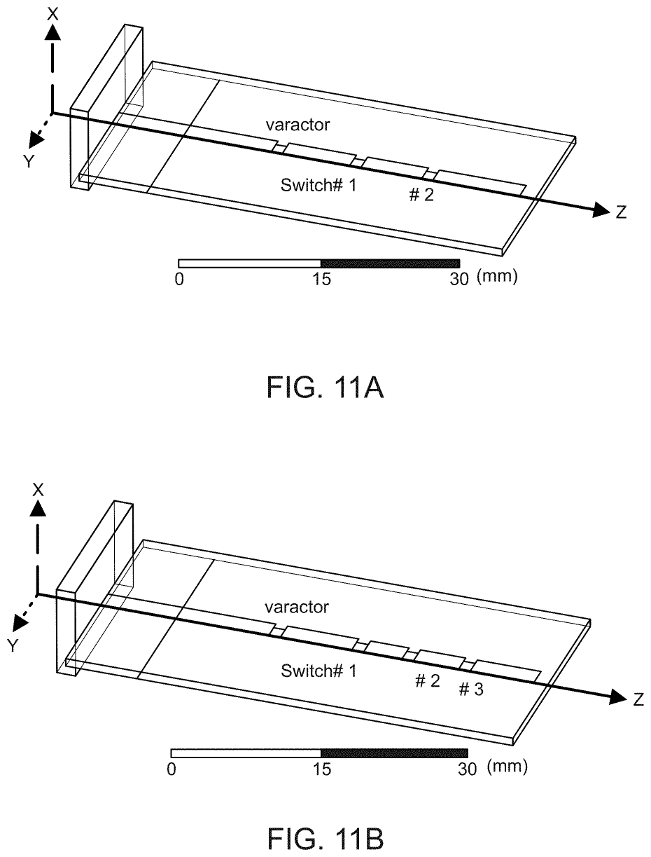

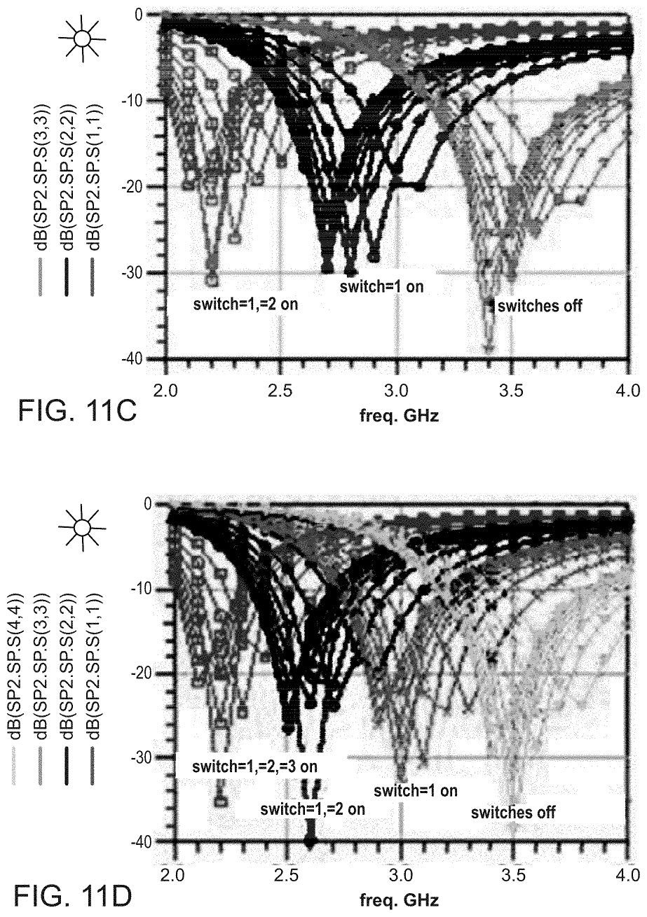

FIGS. 11A-B illustrate two printed monopoles loaded with a varactor for fine tuning and several MEMS switches for coarse tuning. By turning these switches on/off, the monopole length may be varied in real time. FIG. 11A illustrates a two-switch monopole antenna having a center frequency ranging from about 2 to about 4 GHz with about 0.5 GHz instantaneous bandwidth. Continuous operation from 2 to 4 GHz can be enabled by using a serially connected varactor (e.g., having a tuning range of about 0.5 pF-about 2.5 pF). FIG. 11B illustrates a three-switch monopole antenna having a center frequency ranging from about 2 to about 4 GHz with about a few hundred MHz instantaneous bandwidth. The three-switch monopole antenna may provide finer tuning of central frequency compared to the two-switch monopole antenna. FIG. 11C and FIG. 11D illustrate plots of reflection coefficient for the two- and the three-switch antenna in FIG. 11A and FIG. 11B, respectively.

Both the wideband feed and the tunable narrow band feed designs may be extended to include polarization tuning. The polarization of antenna element radiation may be varied to include one or a superposition of horizontal, vertical, and circular polarizations. In one implementation, polarization tuning may be achieved by orienting two or more antenna elements at angle with respect to each other (e.g., at 90 degrees). A Single Pole Double Throw (SPDT) MEMS switch may be utilized to selectively excite the desired polarization.

A birefringent lens design may be used to achieve polarization multiplexing. The birefringent lens may have different focal point locations for different polarizations (e.g., a first focal length for a first polarization and a second focal length for a second polarization). Antenna elements that generate (or receive) radiation having the first polarization may be located at the first focal length and the antenna elements that generate (or receive) radiation having the second polarization may be located at the second focal length. The locations of the first and the second focal lengths may be arranged on a first and a second surface (e.g., first and second concentric spheres), respectively, around the Luneburg lens' surface.

Array of antenna elements arranged around a Luneburg lens may scan outgoing beams over a broad frequency range to any desired direction without the existing phased array issues (e.g., usage of expensive phase shifters, beam deformation at large scan angles, scan blindness, grating lobes, etc.). A novel electronically scanning array structure may be realized by mounting several antenna elements (e.g., transmitters, receivers, etc.) around the Luneburg lens (e.g., see FIG. 1). Instead of having discrete scanning directions using switch-only based feeding method, phase and amplitude of several antenna elements may be controlled (e.g., via control sub-signals). This may lead to finer beam scanning and generation of desired radiation patterns. Unlike a conventional phased array that requires all the antenna elements working simultaneously, the above-mentioned scanning array structure may require a subset of the antenna elements simultaneously emitting to achieve high directional beam scanning. This may be achieved due to the high gain nature of the Luneburg lens. For example, high directional beam scanning between two adjacent sources/detectors (e.g., using a desired radiation pattern) may be achieved by exciting several nearby feed elements.

In one implementation, a 12-degree half power beam width (HPBW) Luneburg lens may be surrounded by antenna elements that are placed 10 degrees apart (e.g., 36 elements in the horizontal plane). In this implementation, beam scanning having a 1-degree accuracy may be achieved by simultaneously driving about 3 to 5 adjacent antenna elements. Therefore, a smaller number of control circuits (e.g., phase shifters) may be needed compared to a conventional antenna array. This results in reduction of system complexity and cost. The Luneburg lens architecture may result in ultra wide frequency range of outgoing beam, broad scan angle coverage, reduction of beam shape variation during scanning, etc.

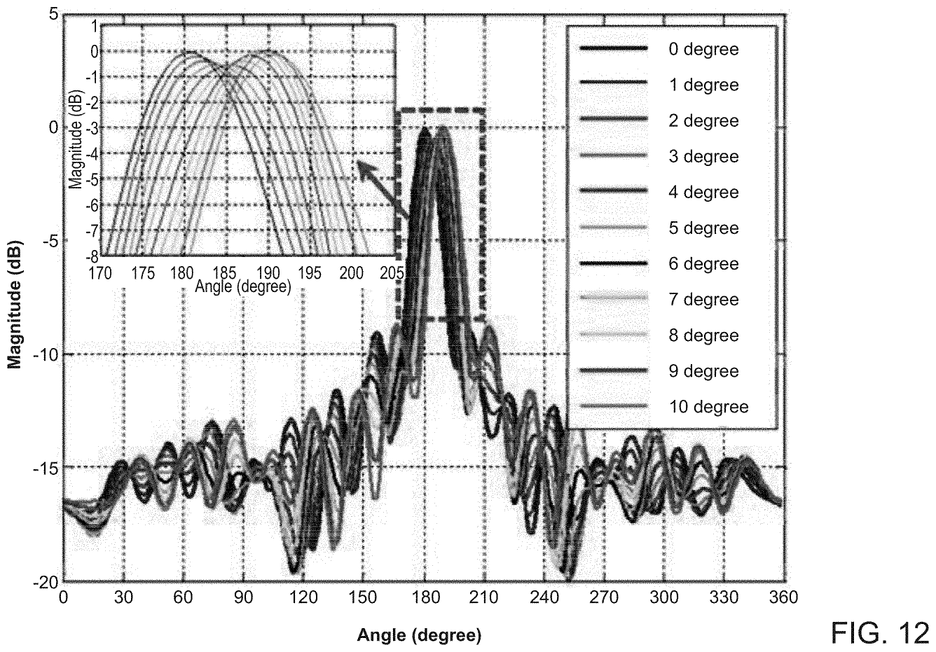

FIG. 12 illustrates exemplary scanning patterns for the Luneburg lens generated by five adjacent antenna elements of the GRIN lens based wireless communication system in FIG. 3. As described above, the system in FIG. 3 includes 36 antenna elements separated by 10 degrees. Excitation of individual antenna elements may result in generation of radiation patterns that are shifted by 10 degrees in the azimuth plane (e.g., the central lobe of the radiation patterns are shifted by 10 degrees). For example, the radiation patterns may be directed at 0, 10, 20, 30 . . . 350 degrees. However, in some implementations, it may be desirable to direct a radiation pattern (e.g., central lobe of the radiation pattern) at an arbitrary angle (e.g., 1, 2, 3, 4, . . . 9 degrees). This may be desirable when an end user device is located at an arbitrary angle with respect to the base station having the Luneburg lens based communication system.

FIG. 12 illustrates radiation patterns directed at angles separated by one degree (e.g., having angular separation of 1, 2, 3 . . . 9 degrees) at 10 GHz radiation frequency. These radiation patterns are obtained by controlling the amplitude and phase of radiation by 5 antenna elements of the 36 antenna elements. As described above, the amplitude and phase of the antenna element radiation can be controlled by the control system.

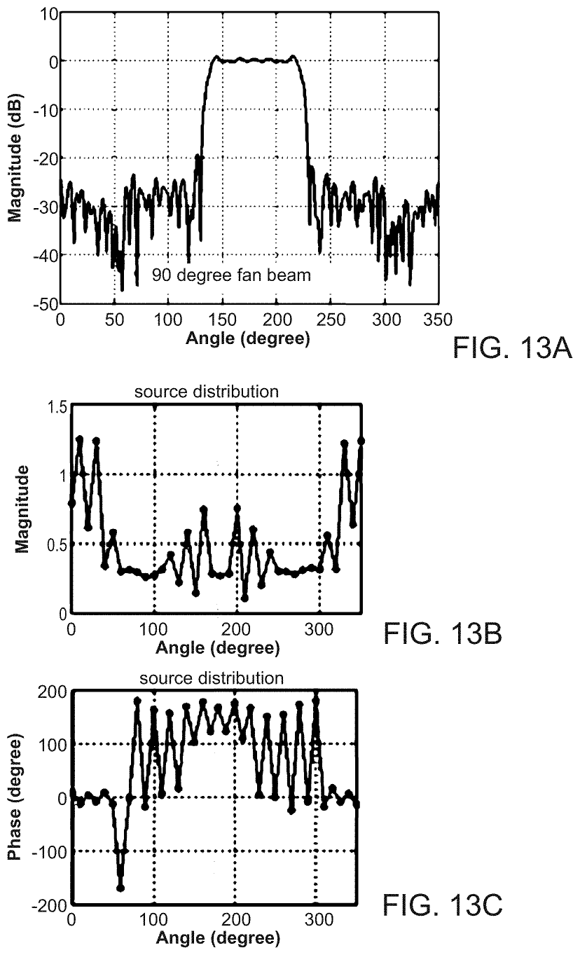

Complex beam shapes (e.g., fan beams) may be generated by exciting several antenna elements (e.g., more than five antenna elements). FIG. 13A illustrates a fan beam generated by 36 antenna elements. The fan beam has a 90 degrees beam width. FIGS. 13B and 13C illustrate plots of magnitudes and phases of the excitation signals (e.g., control sub-signals), respectively. The excitation signals are applied to the 36 antenna elements for fan beam generation. The broad fan beam may be used to communicate with multiple targets within large area or with targets moving across a large area.

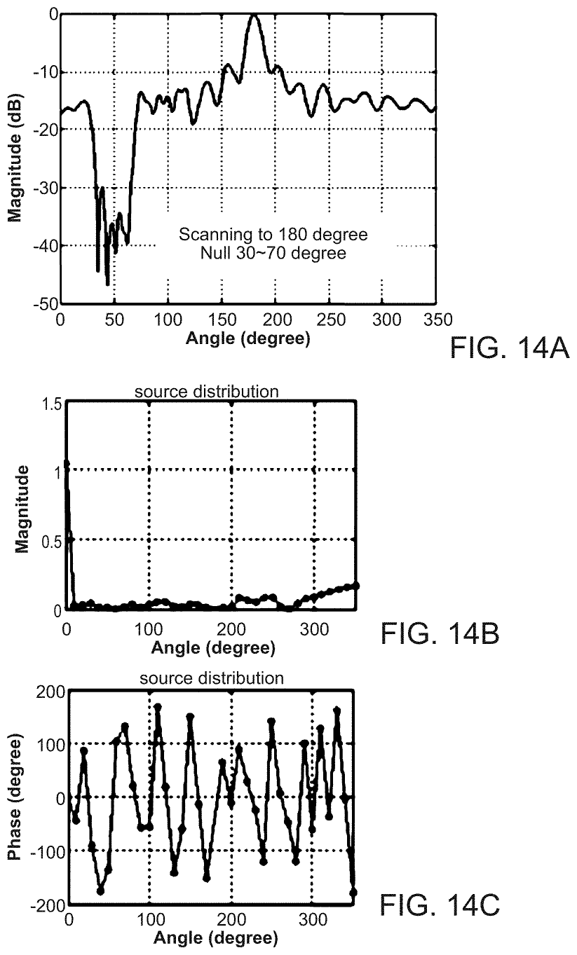

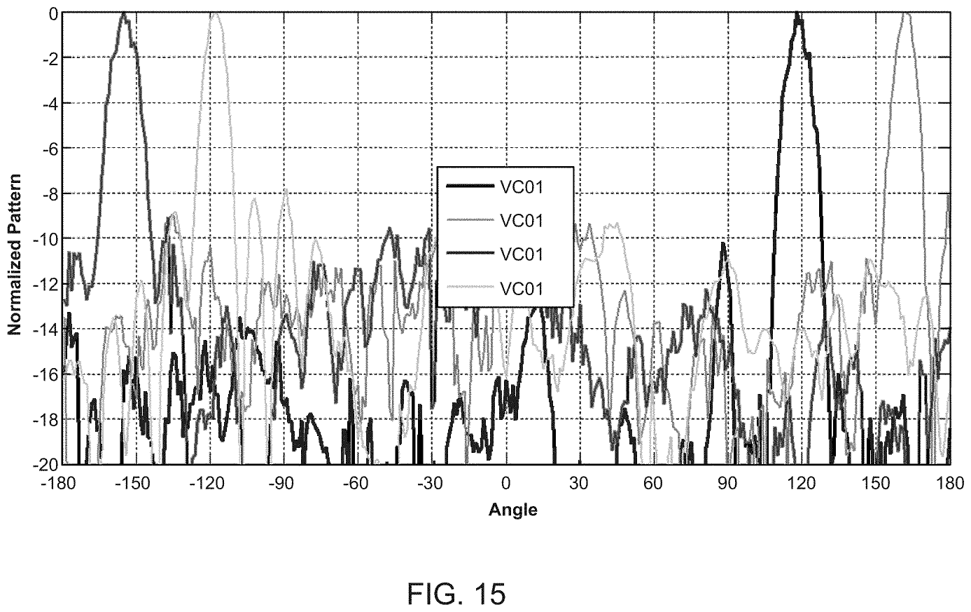

Antenna elements may also be excited to achieve beam nulling (e.g., suppression of outgoing beam generation at certain angles). FIG. 14A illustrates formation of a null beam by 36 antenna elements. The null beam has a beam width of about 40 degrees beam spanning from about 30 degrees to about 70 degrees. The null beam may be scanned over 180 degrees. FIGS. 14B and 14C illustrate plots of magnitudes and phases of the excitation signals (e.g., control sub-signals) applied to the 36 antenna elements for the generation of a null beam. The null beams may be used for interference mitigation purposes. If there are some strong interference coming from certain direction, a null beam may be applied to eliminate that interference. Antenna elements may also be excited to simultaneously generate multiple beams. FIG. 15 illustrates simultaneous generation of four beams directed at different angles.

Communication systems based on Luneburg lens array have higher phase error tolerance compared to a conventional phased array (e.g., a linear array with half wavelength spacing) that rely on the phase control accuracy of each antenna element. By adding random phase errors of various magnitudes (average of 100 for each magnitude) to the input of array elements, beam scanning direction errors are estimated and it is shown that the scanning direction error for the conventional phase array is much larger (e.g., about 10 times larger) than that of the Luneburg Lens Array. Moreover, for the conventional phased array, the scanning error increases linearly with the phase error, while for the Luneburg Lens Array there is almost no impact for phase errors below 20 degrees. This may significantly reduce the performance demand on the control system (e.g., on analog or digital control circuits) of the Luneburg lens based antenna elements array.

Luneburg based communication systems may include a switch matrix that connect multiple antenna elements to a given control circuit. The switch matrix may be configurable and vary the connection between antenna elements and control circuits. For example, a first antenna element may be connected to a first control circuit during a first time period and to a second control circuit during a second time period. The switch matrix may reduce the complexing of the control system. For example, the number of digital/analog control circuits may be reduced (e.g., fewer control circuits than antenna elements). The switch matrix may render the antenna element array reconfigurable without mechanical movements. This may allow for improvements in scanning speed, antenna lifetime and robustness of the communication system.

The switch matrix may include MEMS switches, semiconductor switches or other phase changing material based switches. In some implementations, 4 control circuits units may be coupled to 4 antenna elements. One-dimensional 360 degrees scanning in the azimuth plane may be achieved by 36 elements. Two-dimensional 60 degrees scanning in the azimuth and elevation plane may be achieved using 36 antenna elements (e.g., array of 6×6 elements).

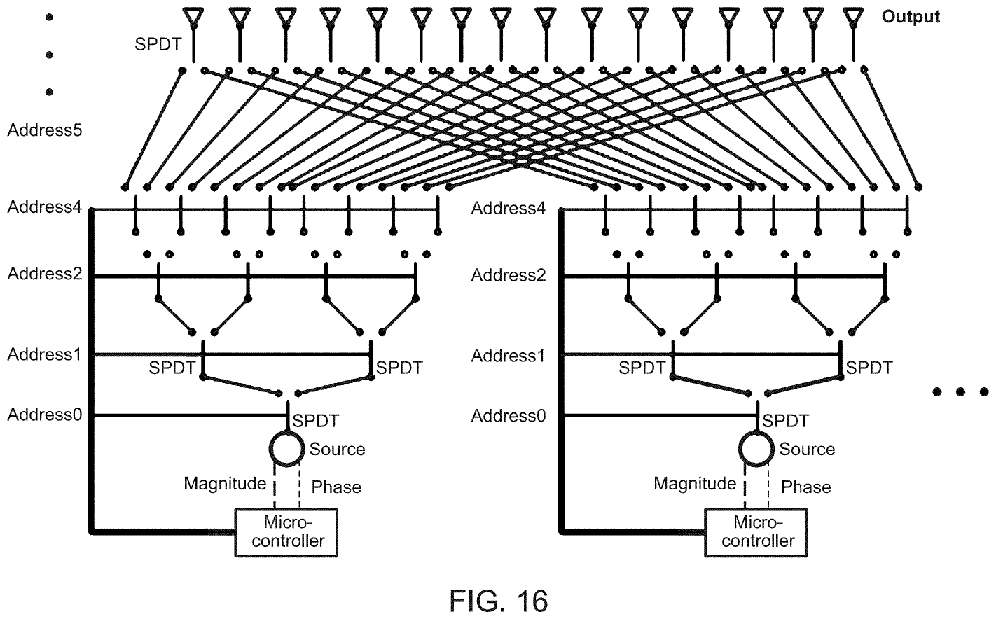

FIG. 16 illustrates an exemplary switching matrix configuration which may allow the output of any control circuit (e.g., a digital beam former) to be routed to any antenna element of the array. The total number of SPDT switches needed is equal to A×(n−1), where A is the number of circuit units and n is the number of antenna elements. For 4 control circuits and 32 antenna elements, 124 SPDT switches are needed. The SPDT switches may be arranged in 5 cascaded stages. This design of switch matrix may result in 2.5 dB of loss (assuming 0.5 dB loss per switch).

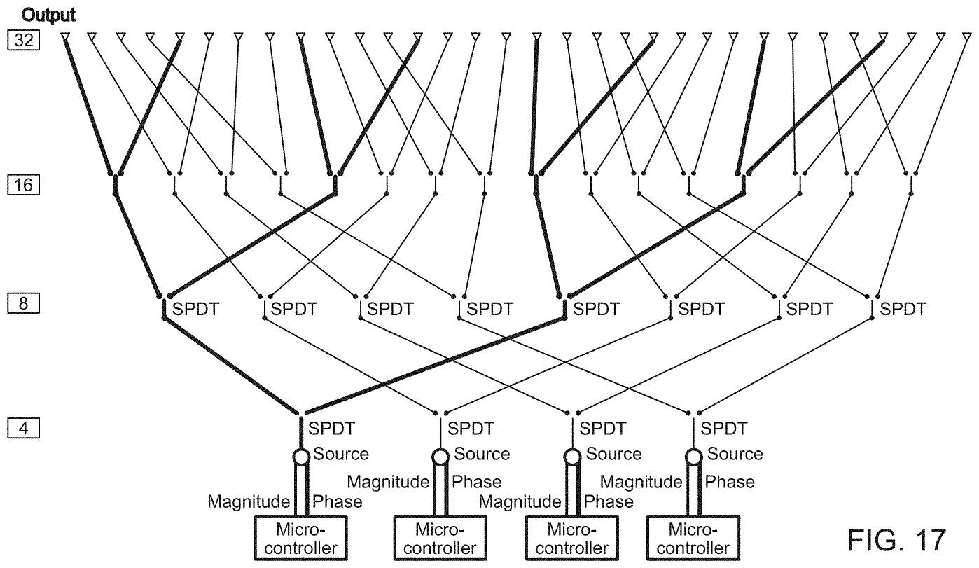

The switch matrix design in FIG. 16 may be very flexible because any control circuit may be routed to any antenna element. In some implementations, such flexibility may not be needed and may be traded off to reduce the number of switches. This may lead to complexity reduction of the switch matrix. FIG. 17 illustrates another exemplary switching matrix configuration. In this configuration, 28 switches are needed to connect 4 control circuits to 32 antenna elements. The number of switches can be further reduced by using SP4T (single-pole-four-throw switch) instead of SPDT (single-pole-double-throw switch).

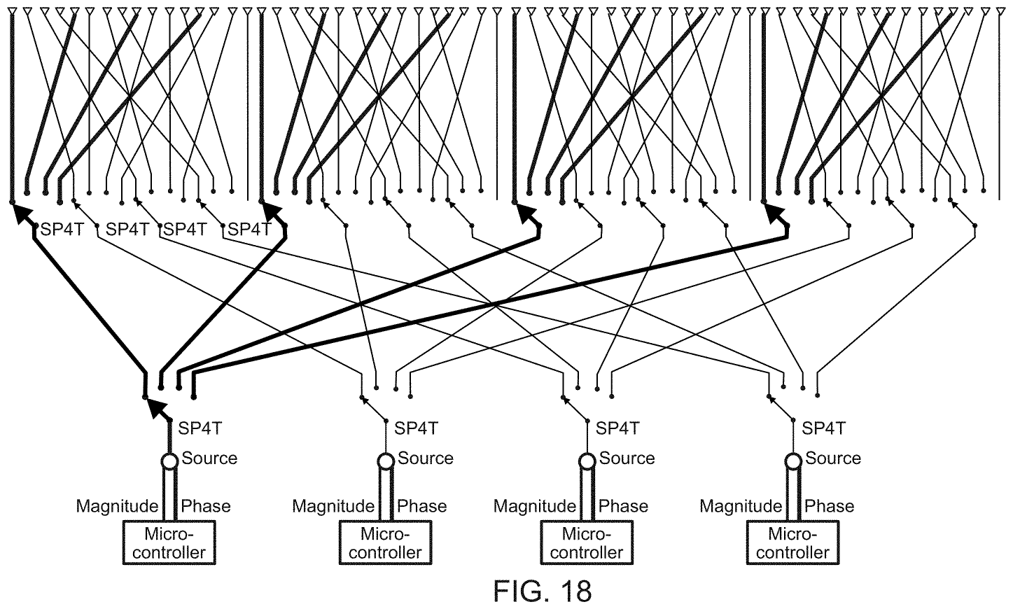

FIG. 18 illustrates another exemplary switching configuration. In this implementation, the total number of SP4T switches needed is equal to (n−A)/3, where A is the number of circuit units and n is the number of antenna elements. For 4 control circuits and 32 antenna elements, 10 SP4T switches are needed.

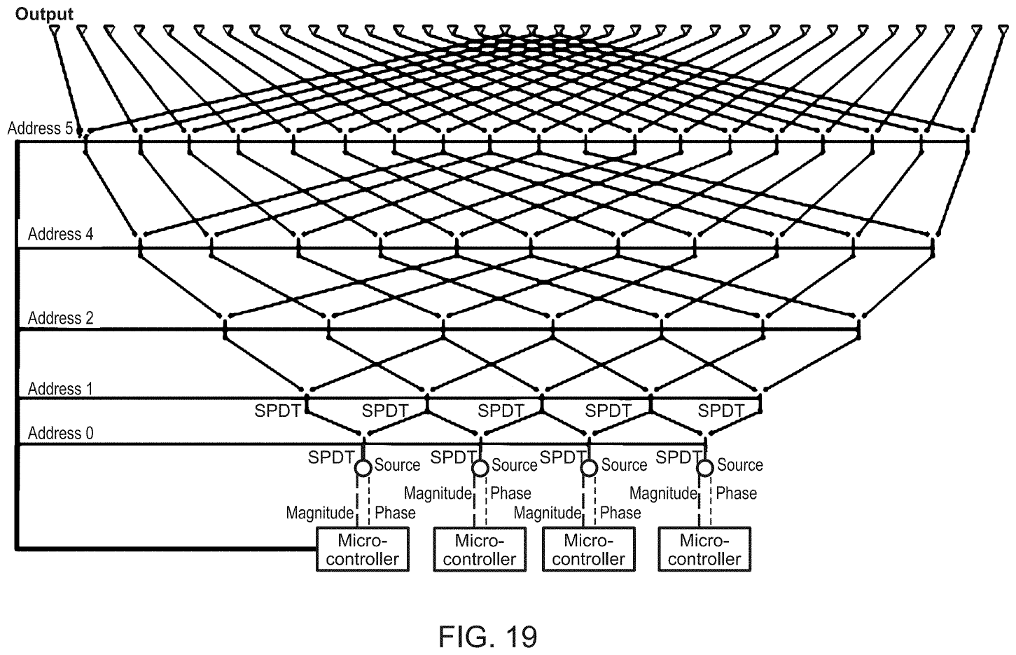

The biasing and control of the switching matrix may also be an important factor in system implementation. In the previous design examples in FIGS. 16-18, every switch needs an independent address line (e.g., for selection of the switch). FIG. 19 illustrates an exemplary switching matrix design where all the switches at a given level may share the same address line. This may be achieved by trading off the number of switches (e.g., the total required number is (n−A)+(A−1)log 2(n−A+1)). For 4 control circuits and 32 antenna elements, 43 SPDT switches are needed. However, no decoder will be needed in the switching matrix system for the switch address.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

1. A communication system comprising:
a Gradient-index lens;
a first plurality of antenna elements arranged on a first surface parallel to a surface of the Gradient-index lens, wherein the first plurality of antenna elements are configured to generate a first plurality of antenna signals in response to receiving a signal from an end user device; and
a control system configured to receive the first plurality of antenna signals from the first plurality of antenna elements and determine an end user direction associated with the end user signal based on a predetermined set of antenna signal values associated with the first plurality of antenna elements.

2. The communication system of claim 1, wherein the predetermined set of antenna signal values include a plurality of subsets of voltage signal values, and the plurality of subsets of voltage signal values are indicative of a plurality of predetermined end user signal directions.

3. The communication system of claim 2, wherein to determine the end user direction, the control system is configured to:
execute a correlation and/or a compressive sensing algorithm that calculates a plurality of correlation values between the first plurality of antenna signals and the plurality of subsets of voltage signal values; and
select the end user direction from the plurality of predetermined end user signal directions based on the calculated plurality of correlation values.

4. The communication system of claim 3, wherein the control system generates a control signal and the first plurality of antenna elements are configured to generate and scan a reference signal in a solid angle based on the control signal, wherein the end user device is configured to generate the end user signal in response to receiving the reference signal.

5. The communication system of claim 4, wherein the reference signal includes a pulsed and/or a frequency modulated signal and the control system is configured to determine an end user distance between the communication system and the end user device based on a time difference between a first time of transmission of the reference signal and a second time of reception of the signal from the end user signal.

6. The communication system of claim of claim 5, wherein the control system is configured to generate a second plurality of control signals to control the operation of the first plurality of antenna elements based on the end user direction and the end user distance.

7. The communication system of claim 1, wherein the plurality of antenna elements are arranged in an azimuth plane of the Gradient-index lens and/or in a sector of elevation of the Gradient-index lens.

8. The communication system of claim 1, wherein a first Gradient-index lens includes a birefringent material configured to focus a first beam having a first polarization at a first distance from the surface of the Gradient-index lens and focus a second beam having a second polarization at a second distance from the surface of the Gradient-index lens.

9. The communication system of claim 8, wherein the first surface is located at the first distance from the surface of the Gradient-index lens, and the first plurality of antenna elements are configured to generate radiation having the first polarization.

10. The communication system of claim 9, further comprising a second plurality of antenna elements arranged on a second surface parallel to the surface of the Gradient-index lens, wherein the second surface is located at the second distance from the surface of the Gradient-index lens.

11. The communication system of claim 10, wherein the second plurality of antenna elements are configured to generate radiation having the second polarization.

12. The communication system of claim 11, wherein a first antenna element of the first plurality of antenna elements has a first orientation and a second antenna element of the second plurality of antenna elements has a second orientation.

13. The communication system of claim 4, wherein the control system includes:
a controller; and
a third plurality of control circuitry configured to generate one or more control sub-signals, wherein the control signal includes the one or more control sub-signals and wherein the controller determines the amplitude and/or phase of the one or more control sub-signals.

14. The communication system of claim 13, wherein the first plurality of antenna elements have a characteristic bandwidth and the controller is configured to determine an operational bandwidth of the one or more control sub-signals, wherein the operational bandwidth lies within the characteristic bandwidth.

15. The communication system of claim 13, wherein the first plurality of antenna elements have a characteristic bandwidth and the controller is configured to vary the characteristic bandwidth by reorganizing radiating sections of the first plurality of antenna elements.

16. The communication system of claim 15, wherein the first plurality of antenna elements are reconfigurable antennas.

17. The communication system of claim 16, wherein the reconfigurable antennas are pixelated printed monopoles.

18. The communication system of claim 13, further comprising a switch matrix configured to electrically connect the first plurality of antenna elements and the third plurality of control circuitry, wherein the switch matrix is configured to connect a first antenna element of the first plurality of antenna elements to a first control circuitry of the third plurality of control circuitry during a first time period and to a second control circuitry of the third plurality of control circuitry during a second time period.

19. The communication system of claim 4, wherein the control system generates a second control signal and the first plurality of antenna elements are configured to generate a communication signal directed to the end user device based on the second control signal.

20. The communication system of claim 19, wherein the control system is further configured to:
determine an interference direction associated with an interference signal; and
generate a reconfiguration signal, wherein the first plurality of antenna elements are configured to generate a null beam directed along the interference direction based on the reconfiguration signal.

21. The communication system of claim 1, wherein the Gradient-index lens includes a Luneburg lens.

22. A method comprising:
providing a communication system comprising a Gradient-index lens, a first plurality of antenna elements arranged on a first surface parallel to a surface of the Gradient-index lens and a control system;
generating, by the plurality of antenna elements, a first plurality of antenna signals in response to receiving a signal from an end user device;
receiving, by the control system, the first plurality of antenna signals from the first plurality of antenna elements; and
determining, by the control system, an end user direction associated with the end user signal based on a predetermined set of antenna signal values associated with the first plurality of antenna elements.

23. The method of claim 22, wherein the predetermined set of antenna signal values include a plurality of subsets of voltage signal values, and the plurality of subsets of voltage signal values are indicative of a plurality of predetermined end user signal directions.

24. The method of claim 22, further comprising:
executing, by the control system, a correlation and/or a compressive sensing algorithm that calculates a plurality of correlation values between the first plurality of antenna signals and the plurality of subsets of voltage signal values; and
selecting, by the control system, the end user direction from the plurality of predetermined end user signal directions based on the calculated plurality of correlation values.

25. The method of claim 24, further comprising:
generating, by the control system, a control signal; and
generating and scanning, by the first plurality of antenna elements, a reference signal in a solid angle based on the control signal, wherein the end user device is configured to generate the end user signal in response to receiving the reference signal.

26. The method of claim 25, further comprising determining, by the control system, an end user distance between the communication system and the end user device based on a time difference between a first time of transmission of the reference signal and a second time of reception of the signal from the end user signal, wherein the reference signal includes a pulsed and/or a frequency modulated signal.

27. The method of claim of claim 26, further comprising generating, by the control system, a second plurality of control signals to control the operation of the first plurality of antenna elements based on the end user direction and the end user distance.

28. The method of claim 22, wherein the plurality of antenna elements are arranged in an azimuth plane of the Gradient-index lens and/or in a sector of elevation of the Gradient-index lens.

29. The method of claim 22, further comprising focusing, by the Gradient-index lens, a first beam having a first polarization at a first distance from the surface of the Gradient-index lens, and a second beam having a second polarization at a second distance from the surface of the Gradient-index lens, wherein, the Gradient-index lens includes a birefringent material.

30. The method of claim 29, further comprising generating, by the first plurality of antenna elements, radiation having the first polarization, wherein the first surface is located at the first distance from the surface of the Gradient-index lens.

31. The method of claim 30, wherein the communication system further comprises a second plurality of antenna elements arranged on a second surface parallel to the surface of the Gradient-index lens, wherein the second surface is located at the second distance from the surface of the Gradient-index lens.

32. The method of claim 31, further comprising, generating, by the second plurality of antenna elements, radiation having the second polarization.

33. The method of claim 32, wherein a first antenna element of the first plurality of antenna elements has a first orientation and a second antenna element of the second plurality of antenna element has a second orientation.

34. The method of claim 25, further comprising:
generating, by a third plurality of control circuitry, one or more control sub-signals, wherein the control system includes the third plurality of control circuitry and a controller, and the controller determines the amplitude and/or phase of the one or more control sub-signals.

35. The method of claim 34, further comprising determining, by the controller, an operational bandwidth of the one or more control sub-signals, wherein the operational bandwidth lies within a characteristic bandwidth associated with the first plurality of antenna elements.

36. The method of claim 34, further comprising varying, by the controller, a characteristic bandwidth of the first plurality of antenna elements by reorganizing radiating sections of the first plurality of antenna elements.

37. The method of claim 36, wherein the first plurality of antenna elements are reconfigurable antennas

38. The method of claim 37, wherein the reconfigurable antennas are pixelated printed monopoles.

39. The method of claim 34, further comprising:
connecting, by a switch matrix, a first antenna element of the first plurality of antenna elements to a first control circuitry of the third plurality of control circuitry during a first time period; and
connecting, by the switch matrix, the first antenna element of the first plurality of antenna elements to a second control circuitry of the third plurality of control circuitry during a second time period.

40. The method of claim 25, further comprising:
generating, by the control system, a second control signal; and
generating, by the first plurality of antenna elements, a communication signal directed to the end user device based on the second control signal.

41. The method of claim 40, further comprising:
determining, by the control system, an interference direction associated with an interference signal;
generating, by the control system, a reconfiguration signal; and
generating, by the first plurality of antenna elements, a null beam directed along the interference direction based on the reconfiguration signal.

42. The method of claim 22, wherein the Gradient-index lens includes a Luneburg lens.
